(19) United States
(12) Patent Application Publication
(10) Pub. No.: US 2015/0128879 A1
(43) Pub. Date: May 14, 2015

(54) RETRACTABLE LEASH

(71) Applicant: RyKo, LLC, Colorado Springs, CO (US)

(72) Inventor: Chantel Anderson, Colorado Springs, CO (US)

(21) Appl. No.: 14/537,553

(22) Filed: Nov. 10, 2014

Related U.S. Application Data
(63) Continuation of application No. PCT/US14/64672, filed on Nov. 7, 2014.
(60) Provisional application No. 61/901,776, filed on Nov. 8, 2013.
(60) Provisional application No. 61/901,776, filed on Nov. 8, 2013.

(51) Int. Cl. A01K 27/00

(52) U.S. Cl. CPC A01K 27/004
USPC 119/796

(57) ABSTRACT

The present invention relates to a leash housing having elements and features permitting a variety of devices and objects to be readily attached to and removed from the housing. The elements and features of the housing do not limit when additional devices and objects can be used with the housing. The leash housing has integrated elements and features as well. Some embodiments of the present invention include one or more leashes combined with one or more housings.

The present application claims the benefits of and priority, under 35 U.S.C. §119(e), to U.S. Provisional Application Ser. No. 61/901,776, filed Nov. 8, 2013, entitled “Retractable Leash;” the above-identified application being fully incorporated herein by reference.

### FIELD OF THE INVENTION

The present invention relates to retractable leashes. The invention can have a variety of objects combined with or removably attached thereto.

### BACKGROUND OF THE INVENTION

A leash is often used to restrain, curb, or otherwise control movement of an animal, child, or moveable object. The connections, or associations, made with leashes are often of a loose, or lax, nature and consequently have a degree of slack during use. Slack in a leash can be removed, however, and the leash made taught. Leashes are most often used with animals, particularly canine and feline pets. Prudence and so-called leash laws impose a duty to utilize a leash when animals are outside an area of confinement. A leash can also be referred to as a lead or tether.

A leash is made of single or multiple lengths of material having clips, clasps, ties, links, loops, or other connectors at one or both ends of the leash material. The leash material is often in the form of chain links, braids, cables, ropes, strips, woven fabric, non-woven fabric, mesh materials, and combinations thereof. Leash materials can be metallic, synthetic, and/or derived from natural materials. The materials can be used alone or in combination.

Leashes can be unconfined or confined in a storage container or housing. Leashes housed in a container can be simply folded and placed inside the housing when not in use. Alternatively, leashes can be wound around a hub or other suitable take-up member of a housing. Reversibly winding a portion of a leash around a hub, reel, or similar take up element, can extend or reduce the length of the leash during use. A housed leash is extended from a housing with pulling forces usually exerted by people, animals, or objects attached to the leash. Other forces such as gravitational forces can also extend a leash from a housing. Conversely, pulling forces retracting a leash into a housing are usually torsional and supplied by manual cranking devices such as a winding, or other take up element, of the housing. Some leash housings have retraction mechanisms for reversibly winding or retracting a leash around a hub, or other take up component, without requiring manual forces. Retraction mechanisms can be mechanical, and/or electrical in construction. Some mechanical retraction mechanisms are spring-based. Many spring-based, or spring-loaded, retraction mechanisms are in the form of reels. These reels often have an actuation mechanism for initiating and stopping rotation of the reel and retraction of the leash. A depressible button, lever, or other member, can be used to release, stop, or otherwise control operation of the retraction mechanism. Depressing the button when some or all of a leash is extended beyond the housing often stops movement of the leash by engaging a braking system and consequent retraction of the leash into the housing. Conversely, not depressing the button or releasing a depressed button allows the leash to move from within the housing to the outside of the housing. A housed leash is maintained in an untangled and compact configuration when not in use. An example of a retractable leash for animals is disclosed by Müller in U.S. Pat. No. 6,904,872.

Published U.S. Patent Application US 2007/0022975 by Arnold discloses a retractable leash with a braking system. The braking system has a casing containing a winding drum, pivoting around an axis, biased in the direction of winding. This winding drum has at least one catch which, when the leash unwinds, automatically extends outwards towards a catch stop. This catch stop can be moved back, by means of a manually operated button, out of the direction of travel of the extended catch. The catch is positioned swivel-mounted on an end face of the winding drum. To turn the catch there is a rotating actuator revolving with the winding drum but limited relative to the same and having, to synchronize the rotating actuator after passing an idle clearance of the rotating actuator relative to the winding drum, two stops, and with the rotating actuator featuring means to extend and retract the catch in the case of rotation relative to the winding drum. To prevent the rotary motion of the rotating actuator, at least one magnet is positioned between the casing and the rotating actuator. No provision for attaching or otherwise combining additional devices, components, or accessories to the device is disclosed.

A retractable leash with an automatic braking system is disclosed in WO 2012/047623 by E K, Joseph. The device includes a retractable leash for restraining an animal attached to the retractable leash. The retractable leash includes a housing, where the housing is configured to substantially cover the other parts of the retractable leash. The retractable leash also includes a spool in the housing and a leash. The leash is wound around the spool and at least a portion of the leash can be extracted from the housing. The retractable leash further includes an automatic brake, where the automatic brake is configured to lock the leash and prevent further extraction of the leash from the housing if the leash is extracted above a threshold speed.

A leash retraction mechanism with a centrifugal braking system is disclosed in U.S. Pat. No. 5,423,494, issued to Kondo. The centrifugal braking system has a spring loaded rope winder having a centrifugal brake mechanism incorporated in the reel of the rope winder with the effect of slowing the winding-up of rope onto the reel.

U.S. Pat. No. 8,252,020, issued to Hauser, et al., discloses an apparatus, a system and a method having a speed-limiting braking mechanism. The apparatus may use a leash to limit a velocity of movement of a pet relative to a velocity of movement of a user of the apparatus. The speed-limiting braking mechanism within the apparatus may prevent the relative velocity from exceeding a predetermined threshold without abruptly stopping unwinding of the leash. The speed-limiting braking mechanism may have a rotatable pinion component connected to one or more brake shoes. The leash may be connected to a spool. Unwinding of the leash may rotate the spool, and rotation of the spool may rotate the pinion component. If the relative velocity exceeds the predetermined threshold, the one or more brake shoes may engage a braking liner to maintain the relative velocity at the predetermined threshold.

Published U.S. Patent Application No. 2006/0266300 discloses a retractable leash having a puller operably connected to an associated pet leash for enabling a pet owner to retract the associated pet leash. The puller comprises a housing and first and second locking elements mounted in the housing. The second locking element is spaced a predetermined distance from the first locking element to allow the associated pet leash extending through the housing to pass therebetween. A trigger assembly is operatively mounted to the housing. A first portion of the trigger assembly engages the first locking element. As the trigger assembly is depressed, the first locking element engages the associated pet leash and presses the associated pet leash against the second locking element thereby preventing movement of the associated pet leash through the puller, in at least a first direction.

As disclosed in U.S. Pat. No. 6,886,499, issued to Meissner, various components can be removably attached to a leash housing. These components include different sized and shaped handles, battery-containing handles for a leash housing with a flashlight component, handles for a housing adapted to contain two or more leashes, and permanent anchoring members for a leash housing. The devices of Meissner are limited by the inability to exchange removably attached handles or anchoring members while a person, animal, or object is connected to the leash and the devices are in use.

Published U.S. Patent Application No. 2011/0197820 by Goldy et al. discloses a pet leash and a method of making and using same. In one embodiment, the leash includes one or more features for improving functionality. In one form, such features include one or more compartments, lighting and timing components or a combination thereof. One such feature is the ability to include numerous storage compartments into the housing and grip. This allows multiple devices, such as a pet water bowl, pet treat compartment and one or more pet waste bags to be stored within the leash. In a particular form, the water bowl is made in a collapsible configuration to facilitate placement in the housing when not in use, and to allow it to expand when removed for use. In a particular form, the storage compartments formed in the housing to hold the various devices may be spaced around a portion of the housing used to contain a pet leash line and its associated retraction mechanism.

U.S. Pat. No. 5,887,550, issued to Levine, et al. discloses a combined pet leash and flashlight comprising a mechanical dispensing and retracting cord for the purpose of tethering, restraining and controlling a pet during a walk.

Published U.S. Patent Application No. 2012/0167834 by Cummings, et al. discloses a storage compartment leash comprising a leash, where the leash includes one of a standard leash and a retractable leash; a handle attached to an end of the leash; a pocket affixed to the leash near the handle, where the pocket holds a plurality of items; an attachment means to connect the pocket to the leash, where the attachment means enables the pocket to be removably attached to the leash; and a closure attached to an opening in the pocket, wherein the closure ensures that the plurality of items do not fall out of the pocket. The pocket attaches to either a standard leash or a retractable leash and is interchangeable between both.

U.S. Pat. No. 5,890,456, issued to Tancrede, discloses a retractable animal leash device for holding and storing animal waste bags therein. The inventive device includes a housing having a spaced apart pair of side panels and a circumferential wall extending between the side panels. A handle is coupled to the housing. The housing has an opening into the interior of the housing. A retractable elongate flexible leash is provided in the interior of the housing. The leash has a free end for attachment to an animal extending through the opening of the housing. Each of the side panels serves as a storage compartment.

A waste-receiving container removably attached to a leash housing is disclosed in U.S. Pat. No. 7,367,286, issued to Beaupre. The container is incidental to the leash housing and could be hand carried or attached to a belt or other item.

Published PCT Application No. PCT/US99/20117 by Timothy Edwards discloses a leash assembly including a retractable leash in combination with a pet refuse bag dispenser. The bag dispenser underlies a handle of the leash assembly and includes a lid for permitting access to an inner cavity in which a plurality of bags are disposed. The bag dispenser is either integrally formed with the leash handle or removably connected to a base of the handle. The plastic bags are disposed within the inner cavity such that the bags may be individually removed. The plastic bags may be selectively removed through a window provided in a side wall of the bag dispenser. The plastic bags may also be removed through a lid having slits through a flexible membrane.

A leash housing adapted to retain a pet food or water container is disclosed by Cigan in published U.S. Patent Application No. 2010/0043721. The container does not influence or enhance the function of the device as a leash housing.

Published Canadian Patent Application No. 2,323,174 discloses an apparatus with six basic functions in one. A built-in retractable leash at the top of the hand held unit is a convenience in controlling the dog by its owner. Secondly, a screw-on bowl allows the owner to unscrew a water tight opening and thus pour water into the bowl for drinking water for the dog. This can be up to four full bowls of water. Thirdly, two separate compartments on one side of the apparatus allows for the user to open the built in door frames. In one compartment are refillable baggies for dog excrement. In the next separate compartment is a space allotted for treats, such as small biscuits or snack food for the dog. On the opposite side of the apparatus is a fully enclosed molded compartment for storing the excrement. This area will be thoroughly sealed in order to eliminate odor. The bottom inner half or more of the container will be filled with water up to and possibly more than a full liter. The apparatus will allow the dog owner to have all of the necessary elements for dog necessities in a convenient container which is light to carry even with water inside.

U.S. Pat. Nos. 7,322,316 and 7,182,044, both issued to Blandford, and U.S. Pat. No. 7,040,256, issued to Wiggins, all disclose an animal control arrangement in which there is provided a plurality of leashes which may be attached to the collars of animals to be controlled while walking, exercising, training or the like and which reduces the likelihood of the leashes becoming tangled.

Published U.S. Patent Application No. 2011/0067649 by O'Brien et al. discloses a no-tangle, retractable leash device for more than one tethered entity, the leash device. The device includes a handle and a housing rotatably carried by the handle. The housing having an interior and at least a first and second aperture communicating the interior with the ambient environment. The device also includes at least a first and second leash reel carried within the housing. The first and second leash reels each carrying a respective leash and being independently rotatable enabling a respective leash to extend through a respective aperture of the housing. A brake inhibits the rotational movement of at least one reel.

U.S. Pat. No. 8,256,385, issued to Goldenberg, discloses a twin pet leash. The device prevents tangling by permitting the reel portion to rotate relative to the handle portion. The device also features individually controllable leash stop mechanisms. Even while an individual leash is stopped, the reel portion can rotate relative to the handle portion so that tangling of the pet leashes is avoided. The leash handle portion has two triggers which are color coded to match the color of the leash, so that a user can readily identify which of the two leashes are to be stopped. Either or both of the leashes can be stopped or released, without interfering with the operation of the other one of the leashes.

Published U.S. Patent Application No. 2012/0318212 by Montenegro discloses a pet leash device designed primarily for pet owners or dog walkers that walk more than one dog. The pet leash device comprises a housing comprising a first and second side portions, a first leash secured to the first side portion, a second leash secured to the second side portion, and a handle secured to the housing. The pet leash device further comprises a rotating pivot component that secures the handle to the housing and allows the housing and the handle to rotate. Additionally, a first connector is secured to an end of the first leash and a second connector is secured to an end of the second leash to secure the first and the second leashes each to a respective dog's collar. Typically, the leashes are retractable within the housing, and a push button controls the extension and retraction of the leashes.

U.S. Pat. No. 8,418,659, issued to Harruna, discloses a leash assembly with a housing for a sanitizer container and a compartment for wipes or napkins. The leash assembly ensures that the sanitizer and wipes or napkins are always with the leash or harness and cannot be forgotten or left behind. Furthermore, this makes it convenient to carry fluids or wipes when walking a pet or infant. The invention enhances personal hygiene, and pet hygiene. The assembly also has a handle with a moveable component.

Published U.S. Patent Application No. 2012/0222630 by Catena discloses a leash for domestic animals comprising a box-shaped body that houses a cord-winding pulley and a handle with open annular profile that ends at the free ends with rotational pins inserted from opposite sides in suitable housings obtained on the sides of a basically rectangular short pipe joined to said box-shaped body. The handle is provided with a button that stops and releases the pulley with the interposition of suitable return means. The handle is composed of two C-shaped semi-parts, each of them ending with one of said rotational pins at one end and with fast coupling and uncoupling mechanisms at the other end.

Published U.S. Patent Application 2008/0105214 by Moulton discloses a retractable pet leash device is provided with a housing containing a storage part and a handle part. The storage part has a cavity to receive a reel to store a leash cord in a retractable or coiled condition. An aperture is provided in the wall of the storage part to permit the withdrawal of the leash cord or to retract the leash cord. A push button provided in the wall of the storage part is operated to retract the leash cord into the storage part. A hinged mechanism containing an elongate member is provided in the handle part provided with a notch portion to receive a stationary object so that the elongate member is pivotally moved to open and close the handle part around a stationary object. For objects of larger size, the leash cord is wound around the object to form a loop and locked into the handle part. Another push button is provided in the handle part to release the elongate member from the locked condition.

Published U.S. Patent Application No. 2006/0266300, by Perkitny discloses a puller operably connected to an associated pet leash for enabling a pet owner to retract the associated pet leash. The puller comprises a housing and first and second locking elements mounted in the housing. The second locking element is spaced a predetermined distance from the first locking element to allow the associated pet leash extending through the housing to pass therebetween. A trigger assembly is operatively mounted to the housing. A first portion of the trigger assembly engages the first locking element. As the trigger assembly is depressed, the first locking element engages the associated pet leash and presses the associated pet leash against the second locking element thereby preventing movement of the associated pet leash through the puller, in at least a first direction.

Accordingly, there remains a need for a leash housing having features permitting a variety of devices and objects to be readily attached to and removed from the housing. The features of the housing would not limit when additional devices and objects could be used with the housing. The leash housing would have integrated features as well.

### SUMMARY OF THE INVENTION

The present invention relates to housed leashes. Leash housings of the present invention have elements, components, and other attachment features integrated and/or combined with the housing. The elements, components, and other attachment features of the housing permit a variety of devices, accessories, and other objects to be readily attached to and removed from the housing. The elements, components, and other attachment features of the housing do not limit or encumber when and if additional devices, accessories, and other objects can be attached to and used with the housing. Accordingly, the housing portion of the present invention has features for reversibly attaching a variety of objects to the housing in a firm manner while permitting ready detachment and release of the objects. In some embodiments, the features have the form of continuous helical ridges or raised threads and complementary depressions, grooves, or valleys in a screw and bolt-like configuration. In other embodiments, the features are posts, pins, or other upright elements and complementary holes, notches, indentations, cutouts, or other openings configured in a matable relationship. These features can also include reversible locking components and associated actuation mechanisms. In other embodiments, magnetic materials are configured and incorporated into housings of the invention to attach or assist in attaching objects to the invention. Attachable objects may also have magnetic materials configured and incorporated therein. In some embodiments of the present invention, one housed leash is combined with one or more other housed leashes.

The housing component of the invention has an integrated handle. At least one portion of the integrated handle is moveable. The remaining portions of the integrated handle are non-moveable. The moveable portion is pivotally attached, or hinged, at one end to a non-moveable portion of the handle. An opposite end of the moveable portion of the handle has features configured to reversibly interlock and seat the moveable portion with an end of the non-moveable portion of the handle. When the moveable portion of the handle is moved away from a non-moveable portion of the handle, an opening is created through which an object can be inserted into space delimited by the handle. The moveable portion of the handle can then be moved back in contact with the non-moveable portion of the handle to close the opening. When in contact with the non-moveable portion of the handle, the moveable portion dovetails and reversibly interlocks with the non-moveable portion of the handle. The moveable portion of the integrated handle enables the handle portion of the invention to serve as a latch. The latch portion of the handle allows the invention to be readily attached to another object, usually a stationary object. The latch also allows the invention to be readily detached from the object. In preferred embodiments, the pivotally attached moveable portion of the handle is spring-activated or spring-loaded. In spring-activated embodiments, the spring component of this latch system urges the moveable portion of the handle to readily move and return to contact, reversibly interlock, and seat with the non-moveable portion of the handle component of the invention. When the moveable handle portion is interlocked, or seated, with a non-moveable handle portion, lateral, or side-to-side, movement of the moveable handle portion relative to the non-moveable portions of the integrated handle is substantially eliminated. Lateral movement of the moveable handle portion can cause the latching action of the handle to fail and result in unintentional detachment of the invention from an object.

In preferred embodiments, the invention has a material covering at least a portion of a housing component and/or an integrated handle portion of the invention. Cover material of the invention can be metallic, polymeric, and/or composite in composition. The cover material can protect an underlying housing component or handle portion of the invention. The cover material can also provide the handle portion with a surface or texture enabling a more firm and secure grip of the invention.

A leash material appropriate for the intended use of the invention is attached to a rotatable spool contained within a housing component of the invention. One end of the leash material is firmly attached to an outer surface, or attachment feature, of the rotatable spool. The other end of the leash material passes through a curved hole, or opening, in the housing component and extends beyond the housing component of the invention. Curvature of the hole, or opening, substantially prevents or eliminates twisting, tangling, or other undesirable geometric distortions of a leash material. A clasp, clip, fastener, and the like is firmly attached to, incorporated in, or otherwise strongly combined with the extended end of the leash material. A leash retraction mechanism is provided in the invention.

A leash retraction mechanism includes a rotatable spool held in place by a fixed axial member, or hub, located in a leash housing component. The rotatable spool is free to turn around the fixed axial member. As the rotatable spool turns one direction or another, the attached leash material either retracts into or extends from the housing component of the invention. The retraction mechanism can be a spring, a crank-based configuration, a motor, or other torque-generating device and combinations thereof.

A braking mechanism can be included in the invention to control rotation of the rotatable spool. The braking mechanism can be attached to or incorporated in the rotatable spool. Preferably, the braking action of the mechanism is started by pressing, or otherwise actuating, a reversibly depressible button configured in the housing component of the invention to mechanically or electronically engage and prevent or resist movement of the rotatable spool. The braking action of the mechanism is stopped or reduced by releasing the depressible button and fully or partially disengaging the braking mechanism. In preferred embodiments, the braking system operates in a controlled or deliberate manner. In more preferred embodiments, the degree to which the braking system controls the rate of braking action varies with the rate of deployment or retraction of the leash. As the leash deploys or retracts at a higher rate, or speed, more braking force is applied to the rotating spool by the braking system. In most preferred embodiments, this speed-controlled braking system progressively reduces the rate of leash deployment or retraction as the leash nears its fully extended length or most retracted length. This helps to minimize or eliminate a sudden stop in movement of the leash and the accompanying rapid increase in the tension of the leash. A rapid increase in the tension of the leash often causes a “jerking” action of the leash. A jerking action of the leash can cause the invention to be pulled from the hand of a user and result in the loss of a tethered pet, child, or object.

Accordingly, one embodiment of the present invention comprises a leash containment apparatus comprising a housing component having an interior area with a substantially cylindrical portion therein configured to retain a rotatable spool having a centralized opening with a diameter, a fixed axial member centrally positioned within said substantially cylindrical portion, said fixed axial member having an outer dimension less than said diameter of said centralized opening of said rotatable spool and permitting unrestricted rotation of said rotatable spool, a curved opening in said housing component sized to permit a substantially planar leash material to readily pass therethrough, an integral handle having a first elongated section with an end, a second elongated section having an end, a moveable section positioned between said end of said first elongated section and said end of said second elongated section; and an opening delimited by said first elongated section, said second elongated section, and said moveable section, wherein said opening has a shape and inner dimension sufficient to receive one or more fingers of a user, wherein one end of said moveable section is pivotally attached to said end of said first elongated section, wherein said end of said elongated first section has an indentation therein configured to receive a portion of said moveable section, wherein an opposite end of said moveable section reversibly interlocks with said end of said second elongated section; and a polymeric cover material placed over at least a portion of said housing.

Another embodiment of the present invention relates to a leash containment apparatus comprising a housing component having an interior area with a substantially cylindrical portion therein configured to retain a rotatable spool having a centralized opening having a diameter, a fixed axial member centrally positioned within said substantially cylindrical portion, said fixed axial member having an outer dimension less than said diameter of said centralized opening of said rotatable spool and permitting unrestricted rotation of said rotatable spool, a curved opening in said housing component sized to permit a substantially planar leash material to readily pass therethrough, an integral handle having a first elongated section having an end, a second elongated section having an end, a moveable section positioned between said end of said first elongated section and said end of said second elongated section; and an opening delimited by said first elongated section, said second elongated section, and said moveable section, wherein said opening has a shape and inner dimension sufficient to receive one or more fingers of a user, wherein one end of said moveable section is pivotally attached to said end of said first elongated section, wherein said end of said elongated first section has an indentation therein configured to receive a portion of said moveable section, wherein an opposite end of said moveable section reversibly interlocks with said end of said second elongated section, and a cover material placed over at least a portion of said housing.

Another embodiment of the present invention relates to a leash containment apparatus comprising a housing having an interior region dimensioned to receive and retain a substantially cylindrical leash retraction mechanism therein, a handle integral with said housing, a polymeric material covering at least a portion of said leash containment apparatus, at least one recessed area positioned on at least one side of said housing, and at least one opening in said housing sized to permit a leash material to readily pass therethrough.

Yet another embodiment of the present invention relates to a leash containment apparatus comprising a housing having an interior region dimensioned to receive and retain a substantially cylindrical leash retraction mechanism therein, a handle integral with said housing, a polymeric material covering at least a portion of said leash containment apparatus, at least one opening positioned on at least one side of said housing dimensioned to receive and reversibly attach a component of an accessory to said housing, and at least one opening in said housing sized to permit a leash material to readily pass therethrough.

Another embodiment of the present invention relates to a leash containment apparatus comprising a first inner section combined with a substantially complementary second inner section to form a housing component, wherein said first inner section has a substantially cylindrical interior portion configured to receive at least a portion of a rotatable spool, wherein said rotatable spool has a centralized opening, wherein said substantially complementary second inner section has an interior portion configured to receive portions of said rotatable spool extending beyond said first inner section, an axial member positioned within said centralized opening of said rotatable spool and affixed to at least one inner section of said containment apparatus, wherein said first inner section has a primary curved projection extending from one side to a terminus, wherein said second inner section has a primary curved projection extending from one side to a terminus, wherein said primary curved projection of said second inner section substantially matches said primary curved projection of said first inner section in shape and is combined with said primary curved projection of said first inner section to form a first component of a handle portion with a terminal end, wherein said first inner section has a secondary curved projection extending from another side to a terminus, wherein said second inner section has a secondary curved projection extending from another side to a terminus, wherein said secondary curved projection of said second inner section substantially matches said secondary curved projection of said first inner section in shape and is combined with said secondary curved projection of said first inner section to form a second component of a handle portion with a terminal end, a moveable handle element pivotally connected at one end to said terminal end of said second component of said handle portion and contactable at an opposite end to said terminal end of said first component of said handle portion, and a first outer covering element combined with a substantially complementary second outer covering element placed over at least a portion of said housing.

Further embodiments, aspects, features, and advantages of the present invention are apparent from the following detailed description. The included drawings illustrate embodiments of the invention and together with the description serve to provide a further understanding of the invention and are not restrictive. It will be apparent to those skilled in the art that modifications and variations to the claimed invention can be made without departing from the spirit or scope of the appended claims and their equivalents.

### BRIEF DESCRIPTION OF THE DRAWINGS

FIG. 1 illustrates an exploded view of an embodiment of the present invention.

FIG. 2 illustrates a side view of an embodiment of the present invention.

FIG. 3 illustrates a view of an embodiment of the present invention having an opening therein for a leash material and the leash material and leash clasp.

FIG. 4 illustrates a view of an embodiment of the present invention having an opening therein for a leash material.

FIG. 5 illustrates an embodiment of the present invention.

FIG. 6 illustrates a perspective view of an embodiment of the present invention.

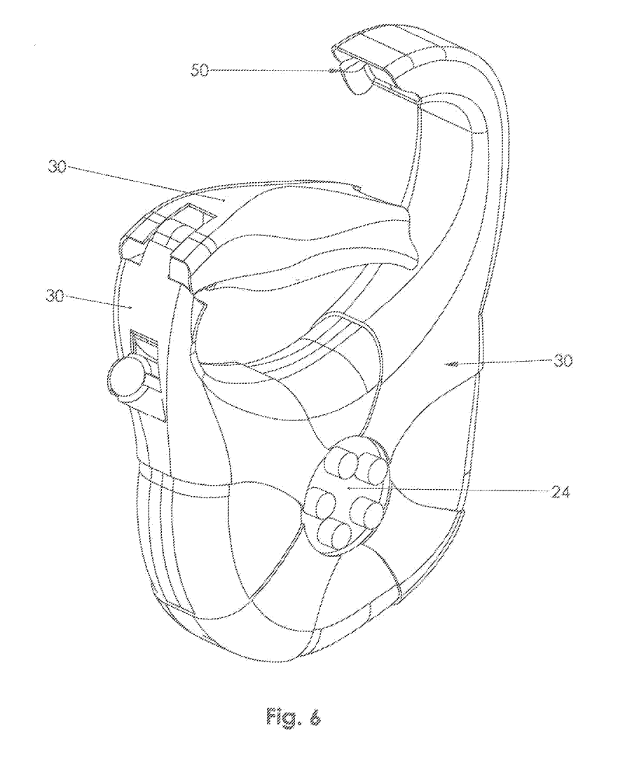

FIG. 7 illustrates a side view of an embodiment of the present invention.

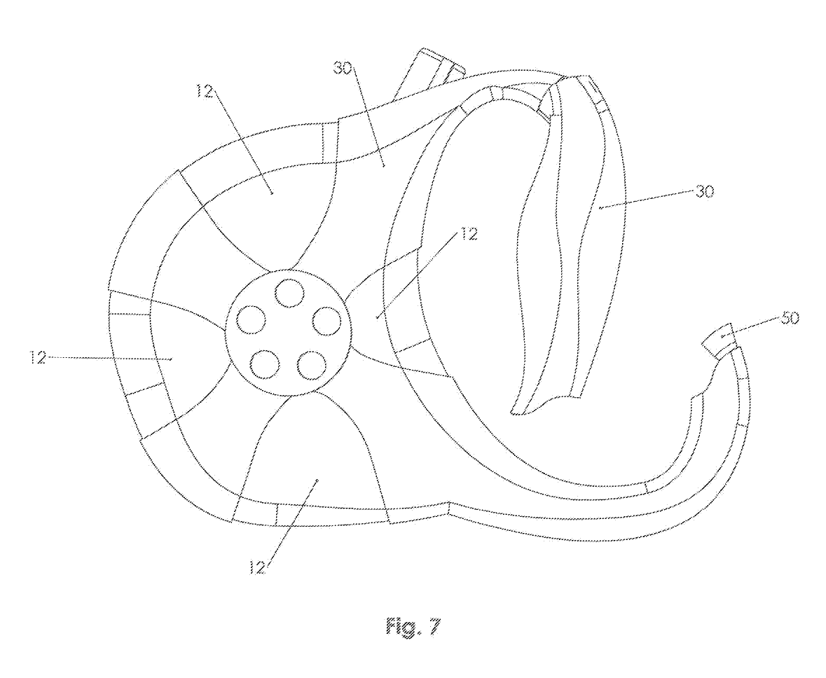

FIG. 8 illustrates a perspective view of an accessory attachment insert with magnetic materials therein of an embodiment of the present invention.

FIG. 9 illustrates a perspective view of an accessory attachment component of an embodiment of the present invention.

FIG. 10 illustrates a plane view of an accessory attachment component of an embodiment of the present invention.

FIG. 11 illustrates a cut-away view of an accessory attachment component of an embodiment of the present invention.

FIG. 12 illustrates a cross-sectional view of an accessory attachment component of an embodiment of the present invention in a vertical orientation.

FIG. 13 illustrates a cross-sectional view of an accessory attachment component of an embodiment of the present invention in a horizontal orientation.

FIG. 14 illustrates a perspective view of an accessory attachment component of an embodiment of the present invention with magnetic materials in an exploded orientation.

FIGS. 15A-D illustrate views of a braking mechanism component of an embodiment of the present invention.

FIGS. 16A-B illustrate cross-sectional views of a braking mechanism component of an embodiment of the present invention.

FIG. 17 illustrates a cross-sectional view of an embodiment of the present invention.

FIG. 18 illustrates a cross-sectional view of an embodiment of the present invention.

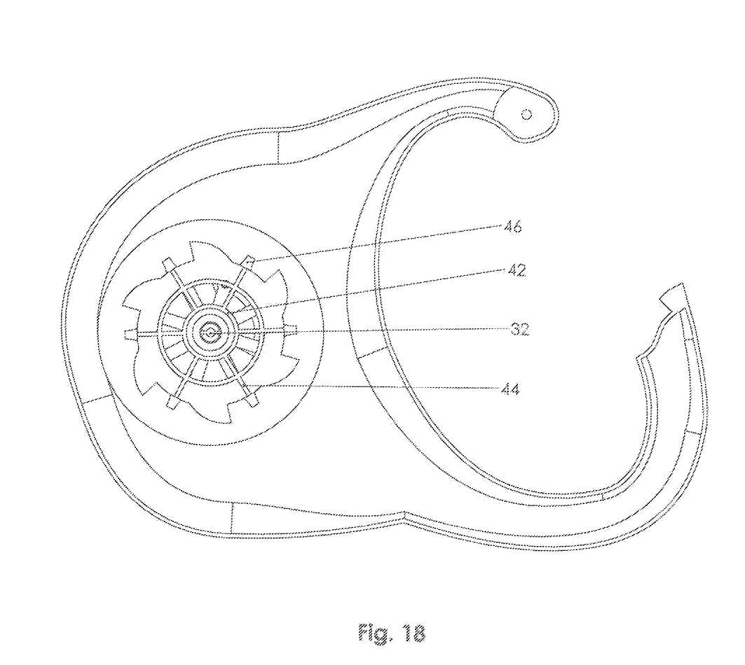

FIG. 19 illustrates a cross-sectional view of a braking mechanism of an embodiment of the present invention.

### DETAILED DESCRIPTION OF THE INVENTION

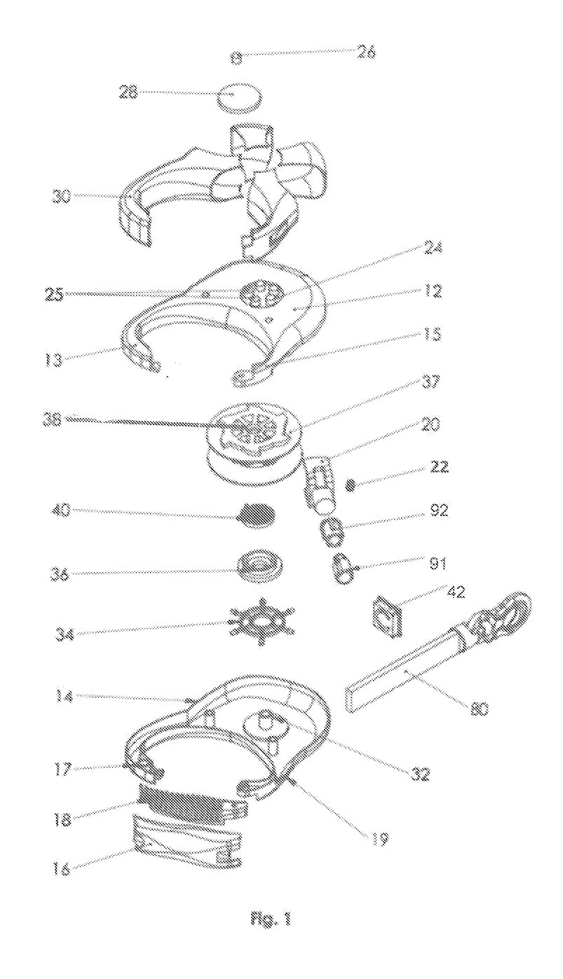

Referring generally to FIG. 1, an exploded view of one embodiment of the present invention is illustrated.

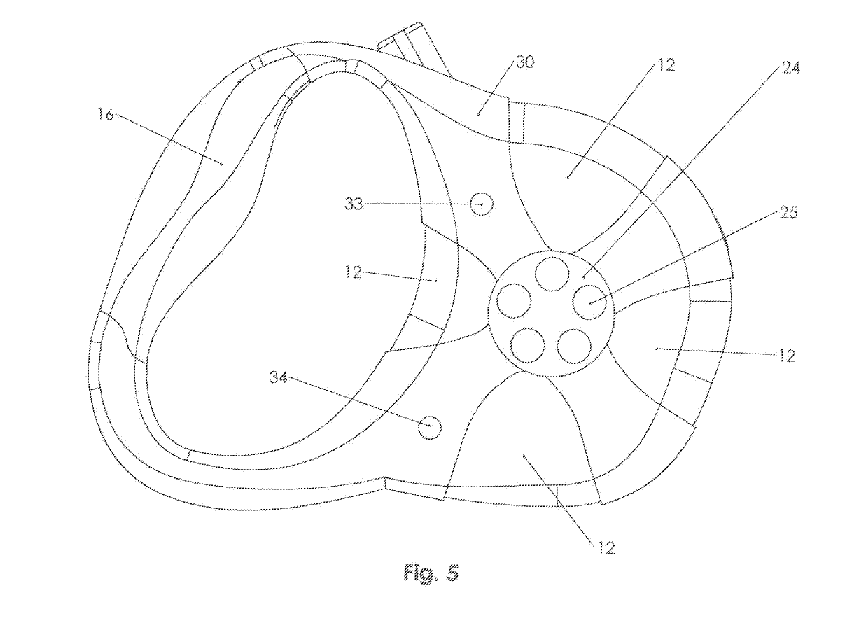

One half of a housing component (12) is shown in mateable relationship to a second housing component (14). Housing component (12) has a main body and two integral handle portions (13, 15) extending from the main body. The extensions (13, 15) form part of a handle. Similarly, housing component (14) has a main body and two integral handle portions (17, 19). The integral handle depicted in FIG. 1 has a moveable portion, or section, formed from two halves (16, 18). The moveable handle portion has two ends. The moveable handle is pivotally connected through a hinge at one end to the “upper” extension of the integral handle formed from halves (13, 17) of the housing component. The other end of the moveable handle portion contacts, interlocks, and seats with a feature of the “lower” extension of the integral handle (50), shown specifically in FIG. 5 for example, formed from housing component halves (17, 19). The upper handle extension, moveable handle portion, and lower handle extension delimit a space sized to accommodate at least one finger of a user. Preferably, the space is sized to accommodate all fingers of a hand of a user.

At least one side of the housing component has at least one facet configured to attach a separate element, component, or accessory to the body of an embodiment of the invention. In many embodiments, the separate elements, components, or accessories are reversibly attached to the housing component. In some embodiments, the facet is a recessed area (24), or depression, in the main body portion of the housing component. The recessed area can have a variety of attachment features. In some embodiments, at least one continuous helical thread adjacent continuous helical depression, groove, or valley is provided along the periphery of the recess. These screw-like attachment features are configured to mate with complementary features on a separate element, component, or accessory intended to be attached to the housing component of the invention. In other embodiments, the recessed area (24) can have attachment features configured to mateably interlock and/or press-fit together with a separate element, component, or accessory. These features include, but are not limited to, channels, tracks, raised areas alone or in combination with lowered areas, lock and key configurations, holes (32) and/or slots (33), as shown in FIG. 5, cutouts, and/or post and notch combinations. In some embodiments, the separate attached elements, components or accessories are free to rotate or otherwise move relative to the invention. In other embodiments, the separate attached elements, components, or accessories are restricted from rotating or otherwise moving with a locking mechanism. Locking mechanisms can be openings with insertable elements, springs, resilient elements, and/or bendable elements. Locking mechanisms can be manually operated, electrically operated, and/or mechanically operated. In some embodiments, the attachment features and the locking mechanisms may be installed on the device as a combined feature, e.g., twist-and-lock mechanism, slide-and-lock mechanism, clip-on mechanism, or snap-on mechanism.

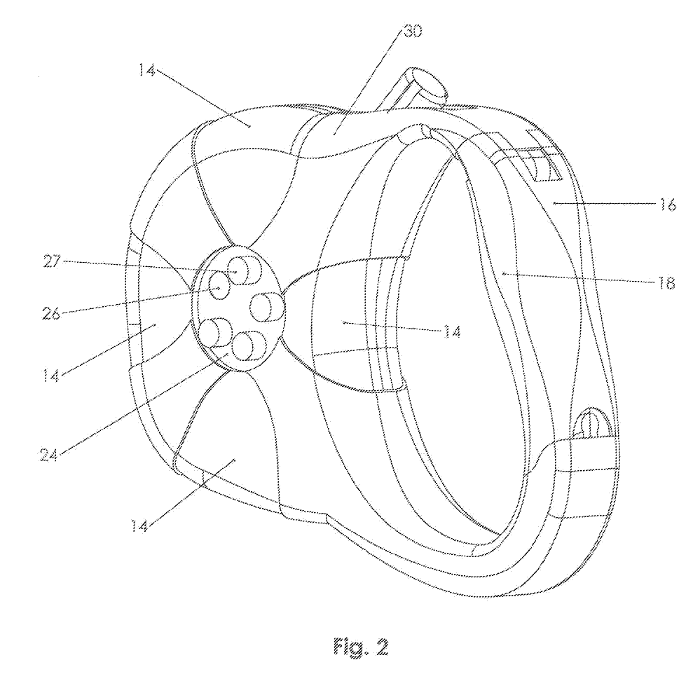

In some embodiments, at least one magnetic material (26) is inserted, attached to, embedded in, or otherwise combined with the housing component (12, 14). In these embodiments, the at least one magnetic material is located in a portion (25) of a recessed area (24). In preferred embodiments, a number of, e.g., four (4), five (5), or six (6), magnetic materials (26) are arrayed in a circular pattern in the recessed area (24). In some embodiments, a resilient material, such as a spring (27) or compressible compound, is placed in the recessed area (24) to aid in removal of an element, component, or accessory from the housing component (see e.g., FIG. 2). Upper surfaces of the magnetic material (26) can be flush, or even, with the surface of the recessed area (24). In these embodiments, the magnetic material (26) is usually embedded in material of the housing component (12, 14). A non-magnetic and/or magnetic material (28) can be placed over the at least one magnetic material (26) in the recessed area (24).

Alternatively, the upper surfaces of the magnetic material (26) can project above the surface of the recessed area (24). Preferred embodiments of the recessed area (24) have four (4), five (5), or six (6) magnetic materials (26) arrayed in a circular pattern around the center of the recessed area (24). The magnetic material (26) can be a ferrous compound or alloy having a north magnetic pole and a south magnetic pole. The magnetic material (26) can be nickel. In these embodiments, an element, component, and/or accessory is attached to the invention with a complementary magnetic material incorporated in the element, component, or accessory.

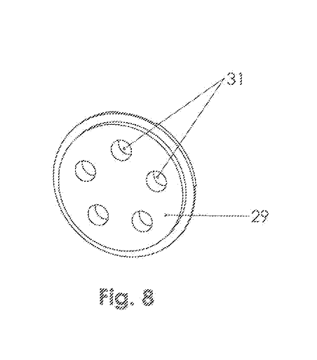

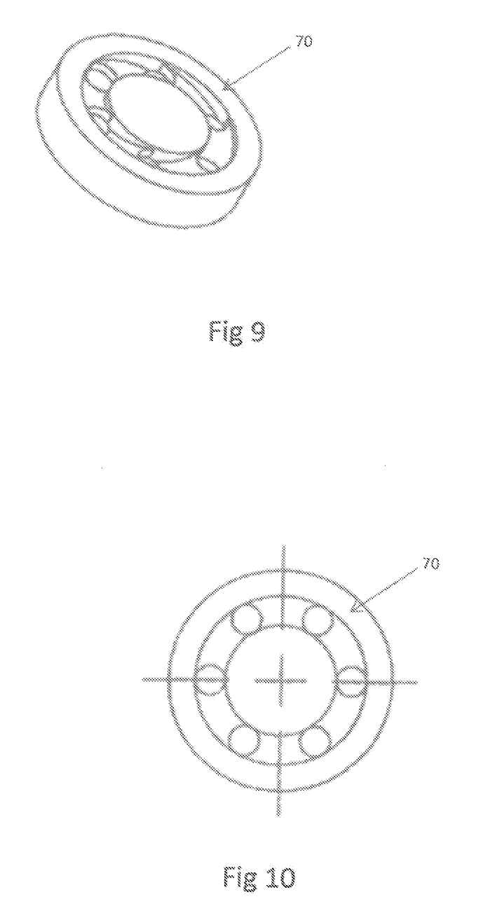

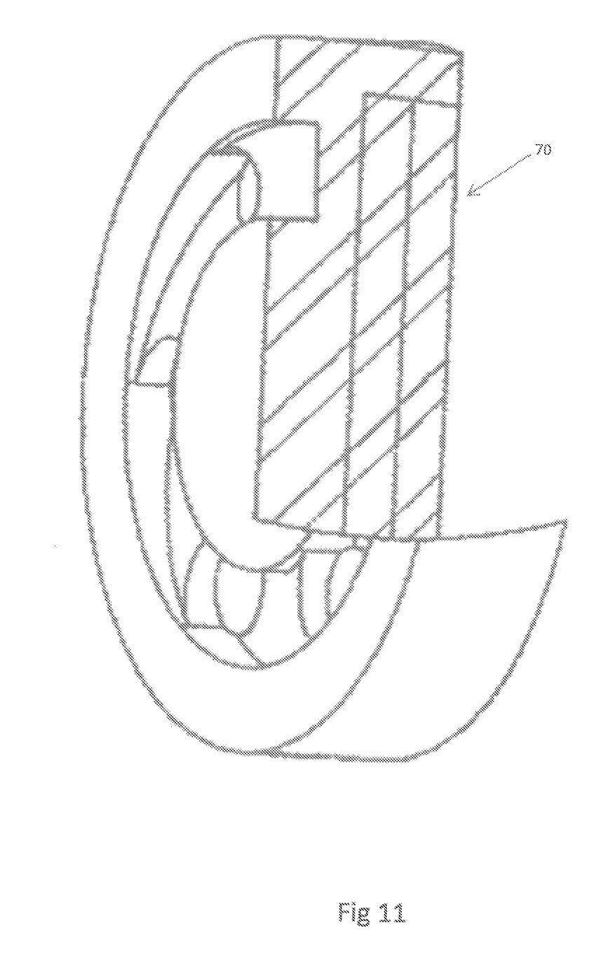

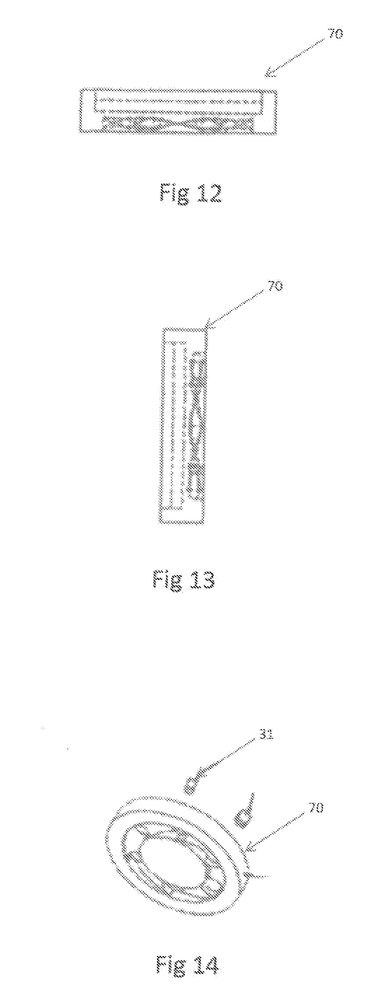

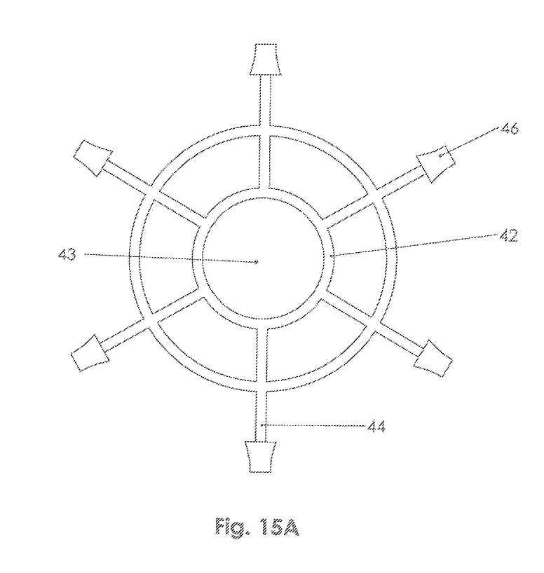

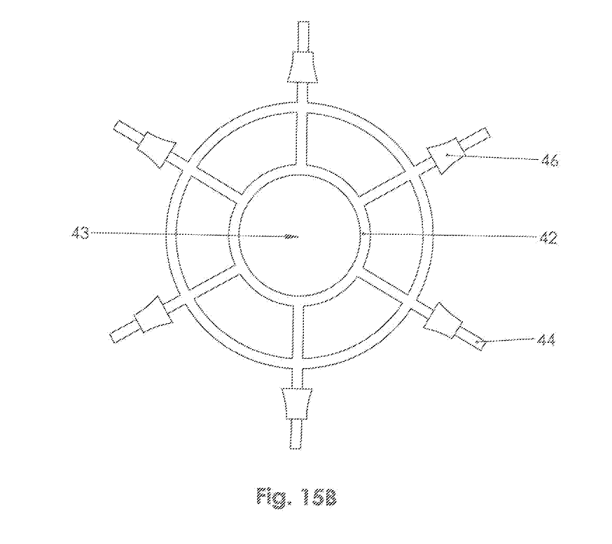

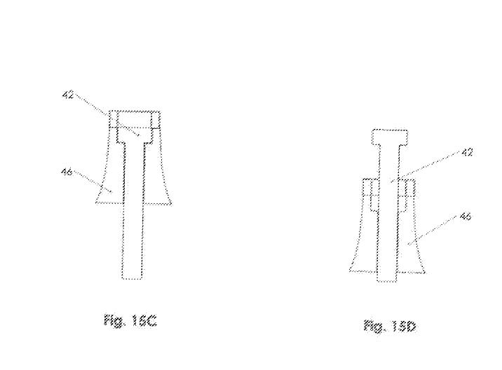

Referring to FIG. 8, in other embodiments, an insert (29) having magnetic material (31) embedded therein can be placed in the recessed area (24). Referring to FIGS. 9-14, an attachment interface (70) can be placed over the insert (29). In preferred embodiments, the attachment interface (70) has indentations on an underside dimensioned and positioned to receive the magnetic material (31) projecting above the underlying insert (29). The attachment interface (70) can be made of non-magnetic and/or magnetic material. The attachment interface (70) can have slopes, slots, notches, holes, threads, groves, depressions, and/or combinations thereof configured to receive complementary attachment components of separate attachable elements, components, and accessories.

A cover material (30) is preferably placed over at least a portion of the housing component (12, 14). The cover material (30) protects the underlying housing component (12, 14). The cover material (30) can have textures, patterned features, and/or compressible portions to enhance or otherwise improve a user's grip or hold on the invention. The cover material (30) can be polymeric, metallic, and/or composite in composition. Examples of suitable cover materials include, but are not limited to, neoprene, latex, styrene, silicone, ethylene propylene diene monomer (M-class) rubber (EPDM), polyvinyl chloride, polyethylene, low density polyethylene (LDPE) and high density polyethylene (HDPE), and polypropylene (PP).

A leash retention mechanism is placed within the two components of the housing (12, 14). The retention mechanism is preferably in the form of a rotatable spool (36, 37, 38). The rotatable spool (36, 37, 38) is held in place in at least one of the housing components (12 or 14) with a fixed axial member (32), or hub, centrally positioned within a substantially cylindrical portion of an interior area of each housing component. The rotatable spool is free to rotate around the fixed axial member. One part of the spool (38) can be made of a substantially planar disk and a circular ring (37) having an inner surface and an outer surface perpendicularly attached on one side to the substantially planar disk. Another substantially planar circular disk (36) is attached to an opposite side of the circular ring (FIG. 1). One end of a leash material (80) is permanently attached to the outer surface of the circular ring by adhering, riveting, screwing, or otherwise fastening the end of the leash material to the other surface of the circular ring and/or affixing the end of the leash material in a notch or other retention feature of the circular ring. When a length of leash material is attached to the spool (36, 37, 38) in an extended configuration, rotation of the spool causes the leash material to wrap around the spool and be retained thereon.

A retraction mechanism can also be included in the retention mechanism. The retraction mechanism is preferably in the form of a constant force spring (40). One end of the constant force spring is permanently attached to the inner surface of the circular ring portion (37) of the rotatable spool (36, 37, 38) and an opposite end of the constant force spring (40) is permanently attached to the fixed axial member (32). As the spool (36, 37, 38) is rotated in one direction, torsional energy is transferred to and stored in the attached constant force spring (40). When the rotatable spool (36, 37, 38) is permitted to rotate in an opposite direction, the stored torsional energy in the constant force spring (40) causes the rotatable spool (36, 37, 38) to rotate around fixed axial member (32) without any externally applied forces. When one end of a length of leash material is attached to the rotatable spool (36, 37, 38) and an opposite end is extended beyond the housing component of the invention, rotation of the rotatable spool component (36, 37, 38) induced by the constant force spring (40) causes the leash material to be automatically wound around the rotatable spool (36, 37, 38) component of the leash retention mechanism and the extended length of leash material to be retracted into the housing component of the invention.

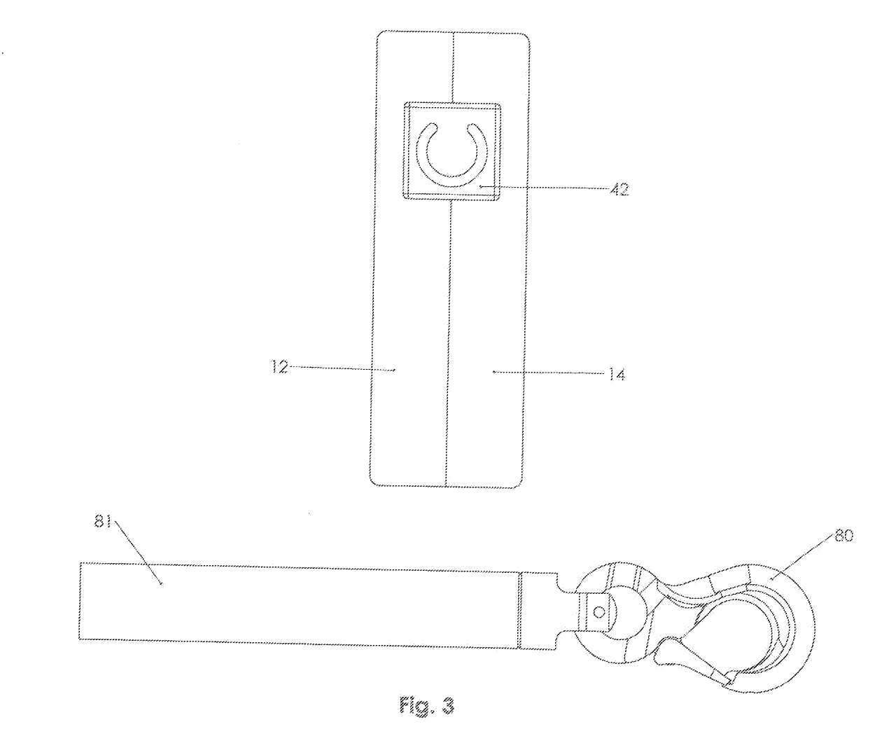

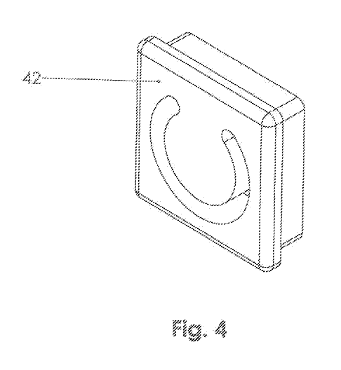

Referring to FIGS. 3-4, the housing component (12, 14) has at least one opening (42), or hole, therein sized to permit a substantially planar leash material to readily move therethrough. The opening (42) is positioned in the housing component on a side substantially opposite the integral handle. Preferably, the opening (42) is curved, arced, or otherwise non-linear or non-circular in shape. A curved shape helps to substantially eliminate or prevent the leash material from tangling, twisting, or otherwise assuming an undesirable shape when moving into the housing and around the leash retention mechanism.

A braking mechanism (34) is preferably included with the rotatable spool component (36, 37, 38) of the leash retention mechanism. The braking mechanism can have a variety of configurations. Some braking mechanisms are mechanical. Other braking mechanisms are electronic. Yet other braking mechanisms are electromechanical.

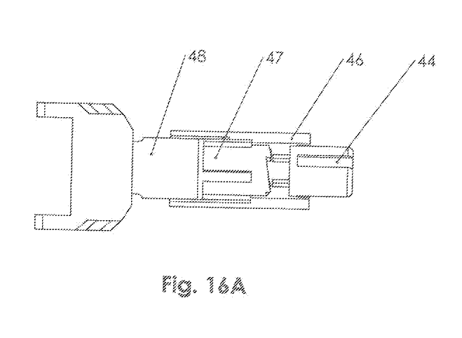

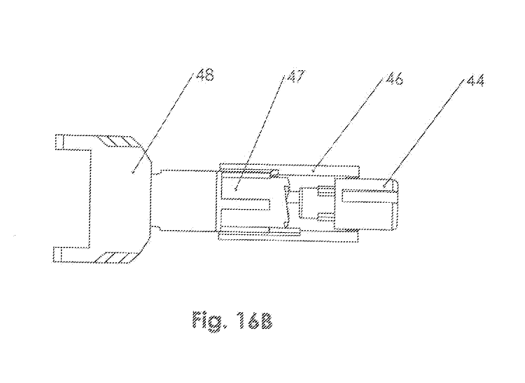

In a preferred embodiment illustrated in FIGS. 15A-D, a circular hub (42) having a central opening (43) and at least one radial spoke (44) is attached to at least one side of the rotatable spool component (36, 37, 38). A slideable hollow mass (46) is captured and retained on each distal end of each radial spoke (44). As such, the captured slideable hollow mass (46) is free to slide on radial spoke (44). When the circular hub (42) is spinning (e.g., as a result of pullback of the leash by constant force spring (4)), centrifugal force may cause the hollow mass (46) to slide away from the center of the radial spoke (44) until an enlarged diameter portion (47) of radial spoke (44) is contacted and stopped by an interior surface of radial spoke (44) as illustrated in FIG. 16B (as opposed to a less slid position in FIG. 16B). As such, a change of rotational speed of the radial spoke (44) (e.g., from zero to a high snap-back speed of the leash quickly returning back to the device by the action of the constant force spring (4)) would be reduced due to some of the resulting force being transferred to the torque of the radial spoke (44) with the hollow mass (46).

In another embodiment, distal end (48) of moveable hollow mass (46) contacts inner surfaces of the circular ring of spool (37). When distal end (48) of slideable hollow mass (46) contact inner surfaces of the circular ring of the rotatable spool component (36, 37, 38), further friction is generated therebetween and the rate of rotation of the leash retention mechanism or the leash retraction mechanism is reduced.

Distal end (48) can be made of the same material as slideable hollow mass (46) and/or a material having a different coefficient of friction. Examples of materials for the slideable hollow mass (46) include, but are not limited to, aluminum, brass, iron, nickel, steel, acetal, acrylic, nylon, polycarbonate, and polyethylene. Examples of materials for the distal end (48) of the slideable hollow mass include, but are not limited to, neoprene, latex, styrene, silicone, polyethylene, and EPDM.

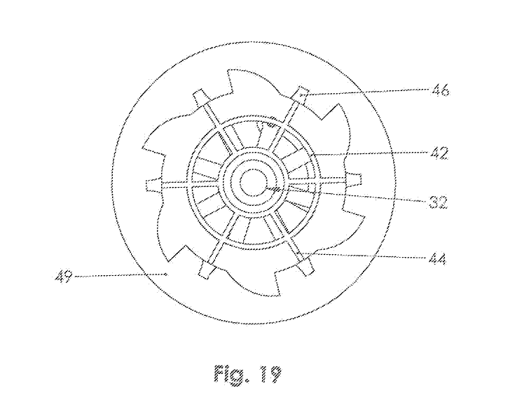

Referring to FIG. 19, in some embodiments, the inner surface of the circular ring (37) of the rotatable spool component (36, 37, 38) has raised areas (49) or otherwise protruding features. The raised areas (49) contact the distal end (48) of the moveable mass (46) and assist in decreasing the rate of rotation of the rotatable spool.

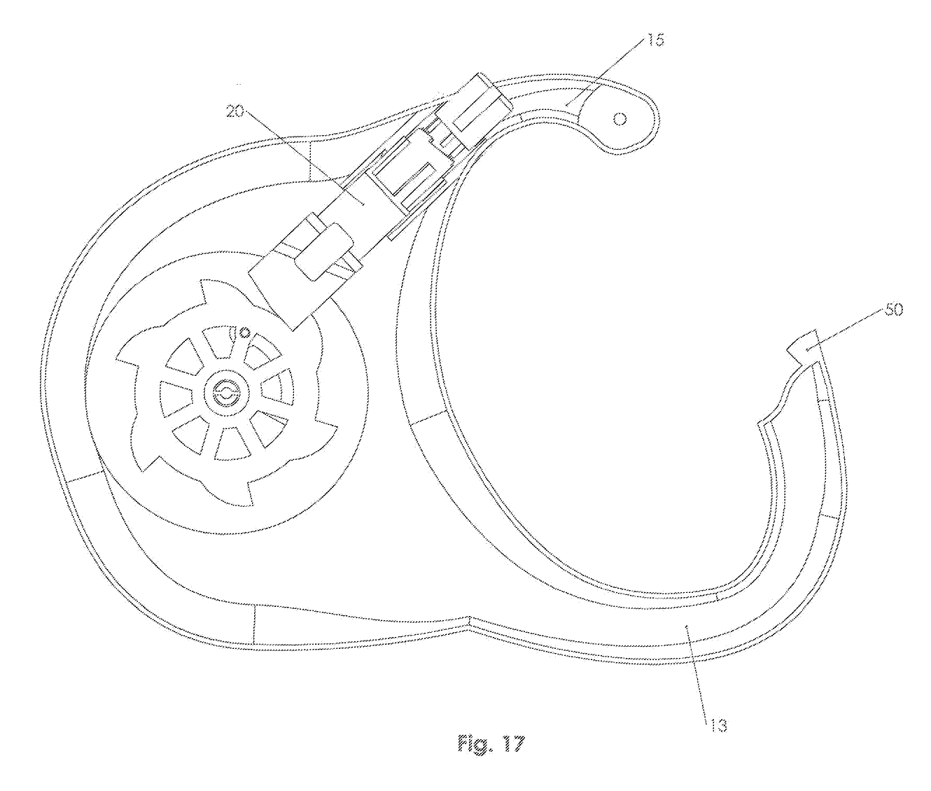

As illustrated in FIG. 17, a brake controlling component (20) is preferably included in the housing component located adjacent to the braking mechanism (34). In preferred embodiments, the brake controlling component (20) has a spring (22) or other resilient device or material incorporated therein. The spring urges the brake controlling component to return to a non-brake controlling, or neutral, location in the housing (12, 14).

In an embodiment, the brake controlling component (20) for the manual braking system is integrated as part of the housing component (12, 14). The brake controlling component (20), also called a lock sleeve or cylinder space around the button pin, acts as a guide for both a push pin (91) and rotating cam (92) of the button system. The push pin (91) slides into grooves on the inside of the lock sleeve (20) (keeping it from rotating and in position). When pressed, the tabs on the push pin (91) contact a sloped surface on the rotating cam (92). Once the push pin (91) is unpressed, the rotating cam (92) is released from the grooves inside the lock sleeve (20). The spring force applied to the push pin (91) will cause the rotating cam (92) to rotate slightly (a result from the slope against the push pin's tabs) creating an engaged lock position, which holds a braking object/wheel lock in contact with the teeth/edges of the circular ring component (37). When the push pin (91) is pressed again, the rotating cam (92) will fall back into the grooves of the lock sleeve (20), creating a disengaged position where the braking object/wheel lock is not in contact with the circular ring component (37). As such, the lock sleeve (20) alternates between “locked” and “open” position. The rotating cam (92) will keep a force on the wheel lock, holding it in the lock or open positions. A spring is located inside the wheel lock and attaches to the housing component (12, 14). The wheel lock is held in place/kept from rotating from grooves in the housing component (12, 14).

### EXAMPLES

### Example 1

This example describes construction of an embodiment of the present invention. The embodiment (10) illustrated in FIG. 1 was made of two mated housing components (12, 14). The housing components were molded of a thermoformed plastic material. The mated housing components were approximately 5.5 inches (14 cm) in length, 4 inches (10 cm) in height, and 1 inch (2.54 cm) in width. Once inner mechanical components of the invention were installed inside the housing, the two molded halves (12, 14) of the housing component were held together with three (3) screws.

A fixed axial member (32) having a substantially cylindrically shape approximately 0.4 inches (1 cm) was part of the inner wall of one molded housing component (14). The fixed axial member (32) projected from the inner wall of the housing component (14) in a substantially perpendicular orientation. When the two halves (12, 14) of the housing component were secured together in the final construction steps, the fixed axial member form an axle, or hub, component (32) of the invention. The fixed axial member (32) was centrally located in a substantially cylindrically shaped area located inside the housing component. The substantially cylindrically shaped area inside the housing component held a leash retention mechanism (36, 37, 38), retraction mechanism (37, 40), and a leash braking mechanism (34) in place within the housing component.

A leash retention and leash retraction mechanism was made as follows. A first substantially planar 2.5 inch (6.35 cm) diameter thermoplastic disk (36) having a 0.4 inch (1 cm) diameter centralized hole was placed over the fixed axial member (32). One end of a strip of stainless steel 0.1 millimeters in thickness, 7.62 millimeters in width, and 4.5 meters long was then permanently attached to fixed axial member (32). The stainless steel strip was wound into a coil (40) around fixed axial member (32) and the free, unattached end, permanently attached to an inner surface of a circular, ring-shaped, thermoplastic component (37) approximately 2 inches (5 cm) in diameter, 0.5 inches (1.25 cm) in width, and 0.1 inches (3 mm) in thickness. The circular ring-shaped thermoplastic component (37) was molded with a second thermoplastic circular disk (38) 2.5 inches (6.35 cm) in diameter having a 0.4 inch (1 cm) diameter centralized hole. The first thermoplastic disk was adhered to the second thermoplastic disk to form a rotatable spool (36, 37, 38) having the attached constant force spring component (40) enclosed therein to form a controllable, spring-loaded, leash deployment and retraction mechanism.

A braking mechanism for controlling the speed leash deployment and length of retraction was constructed as follows. The fixed axial member (32) of molded housing component half (12) was inserted through the centralized hole (43) of one braking mechanism component (34) and the braking mechanism component (34) attached to one side (36) of a leash retention mechanism in the form of a rotatable spool (36, 37, 38). The braking mechanism component (34) had six (6) radial spokes (44). Each radial spoke (44) had a slidable mass (46) placed over a distal end thereof. Each slidable mass (46) was retained on a radial spoke with an enlarged diameter portion (47) at the distal end of each spoke (FIGS. 16A-B). Each slidable mass (46) had a distal end (48) made of friction generating material such as vulcanized rubber.

As illustrated in FIG. 17, a brake controlling component (20) was included in the housing component. The brake controlling component (20) was located adjacent to the braking mechanism (34). The brake controlling component (20) had a spring (22) incorporated therein. The spring was used to move the brake controlling component into a non-brake controlling, or neutral, location in the housing (12, 14).

Raised areas (49) were molded on inner surfaces of circular ring component (37). The raised areas were used to contact the distal ends (48) of slidable masses (46) to decrease the rate of rotation of rotatable spool (36, 37, 38).

A seven foot (2.1 m) length of a flexible and robust nylon strap material (81) approximately 0.75 inches wide (1.91 cm) was obtained from Strapworks.com, (Eugene, Oreg.). The nylon strap material (81) was used as a leash, tether, or lead in an embodiment of the present invention. A metal clasp (80) obtained from Strapworks.com, (Eugene, Oreg.) was firmly attached to, or otherwise incorporated with, one end of the nylon strap material (81). The metal clasp (80) was configured to securely and reversibly attach to a component of a collar, harness, hitch, or similar constraining device. The end of the nylon strap material (81) opposite the clasp (80) was permanently attached to the outer surface of the ring-shaped component (37) of the leash deployment and retraction mechanism. The remaining nylon strap material (81) was wound around the ring-shaped component (38) of the leash deployment and retraction mechanism and confined in a circular configuration between the first and second circular thermoplastic disks (36, 38) of the leash deployment and retraction mechanism.

1. A leash containment apparatus, comprising:
a housing component having an interior area with a substantially cylindrical portion therein configured to retain a rotatable spool having a centralized opening with a diameter;
a fixed axial member centrally positioned within said substantially cylindrical portion, said fixed axial member having an outer dimension less than said diameter of said centralized opening of said rotatable spool and permitting unrestricted rotation of said rotatable spool;
a curved opening in said housing component sized to permit a substantially planar leash material to readily pass therethrough;
an integral handle having a first elongated section with an end, a second elongated section having an end, a moveable section positioned between said end of said first elongated section and said end of said second elongated section; and an opening delimited by said first elongated section, said second elongated section, and said moveable section, wherein said opening has a shape and inner dimension sufficient to receive one or more fingers of a user;
wherein one end of said moveable section is pivotally attached to said end of said first elongated section;
wherein said end of said elongated first section has an indentation therein configured to receive a portion of said moveable section;
wherein an opposite end of said moveable section reversibly interlocks with said end of said second elongated section; and
a polymeric cover material placed over at least a portion of said housing.

2. The leash containment apparatus of claim 1, further comprising a reversibly depressible element having one end extending externally from said housing and an opposite end located within said housing and configured to contact at least a portion of said rotatable spool and stop rotation of said rotatable spool when depressed.

3. The leash containment apparatus of claim 1, further comprising a resilient element having one end in contact with said moveable section and an opposite end in contact with said first elongated section across said pivotal attachment between said moveable section and said first elongated section.

4. The leash containment apparatus of claim 3, wherein said resilient element is a metallic strip.

5. The leash containment apparatus of claim 1, wherein of an end of said moveable section opposite said end pivotally attached to said first elongated section has a notch therein and said end of said second elongated section has a portion extending therefrom dimensioned to fit within said notch, wherein said notch and said extended portion reversibly interlock.

6. The leash containment apparatus of claim 1, further comprising a rotatable spool having a centralized opening with a diameter, wherein said axial member has an outer dimension less than said diameter of said centralized opening and is placed within said centralized opening.

7. The leash containment apparatus of claim 6, further comprising a constant force spring element placed within said rotatable spool;
wherein one end of said constant force spring element is attached to said fixed axial member and an opposite end of said constant force spring element is attached to an inner surface of said rotatable spool.

8. The leash containment apparatus of claim 6, further comprising at least one rotation control component combined with said rotatable spool;
wherein said rotation control component has a multiplicity of radial spokes each attached at one end to a hub with a centralized opening;
wherein said fixed axial member is placed through said centralized opening of said hub;
wherein at least one radial spoke has a slidable hollow mass retained thereon;
wherein said slidable hollow mass has an inner dimension and is retained on said at least one radial spoke with a distal element on said at least one radial spoke exceeding said inner dimension of a portion of said slidable hollow mass;
wherein said slidable hollow mass is configured to move and contact an inner surface of said substantially cylindrical portion of said housing under centrifugal forces exerted on said slidable hollow mass.

9. The leash containment apparatus of claim 8, wherein said slidable hollow mass is configured to move away from said inner surface of said substantially cylindrical portion of said housing and discontinue contact with said inner surface of said substantially cylindrical portion of said housing in the absence of centrifugal forces exerted on said slidable hollow mass.

10. The leash containment apparatus of claim 8, further comprising at least one raised area combined with at least one portion of said spool rotation control component and aligned with said rotatable spool component on at least one side of said rotatable spool component.

11. The leash containment apparatus of claim 1, further comprising one or more magnetic materials inserted in a side portion of said housing.

12. The leash containment apparatus of claim 1, further comprising one or more magnetic materials inserted in a side portion of said housing and surrounded by a concomitant opening in said cover material.

13. The leash containment apparatus of claim 1, further comprising at least one combination of raised and recessed areas in said housing configured to receive and releasably retain an accessory having raised and recessed areas complementary to said raised and recessed areas in said housing.

14. The leash containment apparatus of claim 1, further comprising at least one combination of raised and recessed areas in said cover material and underlying housing configured to receive and releasably retain an accessory having raised and recessed areas complementary to said raised and recessed areas in said housing and said cover material.

15. The leash containment apparatus of claim 1, further comprising one or more openings in said housing, wherein said openings receive and releasably retain at least one portion of an accessory having attachment features complementary to said openings of said leash containment apparatus.

16. The leash containment apparatus of claim 1, further comprising one or more openings in said covering material and underlying housing, wherein said openings receive and releasably retain at least one portion of an accessory having features complementary to said openings in said covering material and underlying housing.

17. The leash containment apparatus of claim 6, further comprising a substantially planar length of leash material attached at a proximal end to an outer surface of said rotatable spool.

18. The leash containment apparatus of claim 17, further comprising a connector attached to a distal end of said length of leash material.

19-36. (canceled)

37. A leash containment apparatus, comprising:
a housing having an interior region dimensioned to receive and retain a substantially cylindrical leash retraction mechanism therein;
a handle integral with said housing;
a polymeric material covering at least a portion of said leash containment apparatus;
at least one recessed area positioned on at least one side of said housing; and
at least one opening in said housing sized to permit a leash material to readily pass therethrough.

38-56. (canceled)

57. A leash containment apparatus, comprising:
a housing having an interior region dimensioned to receive and retain a substantially cylindrical leash retraction mechanism therein;
a handle integral with said housing;
a polymeric material covering at least a portion of said leash containment apparatus;
at least one opening positioned on at least one side of said housing dimensioned to receive and reversibly attach a component of an accessory to said housing; and
at least one opening in said housing sized to permit a leash material to readily pass therethrough.

58-77. (canceled)
